(19) United States
(12) Patent Application Publication
(10) Pub. No.: US 2012/0113340 A1
(43) Pub. Date: May 10, 2012

(54) LIQUID CRYSTAL DISPLAY PANEL, LIQUID CRYSTAL DRIVE DEVICE, AND LIQUID CRYSTAL DISPLAY DEVICE

(75) Inventors: Hiroshi Yaguma, Kyoto-shi (JP); Makoto Kitagawa, Meerbusch (DE)

(73) Assignee: ROHM CO., LTD., Kyoto (JP)

(21) Appl. No.: 13/292,666

(22) Filed: Nov. 9, 2011

(30) Foreign Application Priority Data
Nov. 10, 2010 (JP) 2010-252213

(51) Int. Cl. G02F 1/1343

(52) U.S. Cl. 349/33; 349/143

(57) ABSTRACT

The liquid crystal display panel according to the present invention comprises a plurality of gate lines, a plurality of source lines, and a plurality of liquid crystal pixels, wherein the plurality of source lines and the plurality of liquid crystal pixels are laid out so that the polarity of voltage to be applied to the plurality of liquid crystal pixels is inverted for individual dots for the liquid crystal display panel overall, and so that the polarity of voltage to be applied to the plurality of source lines is not inverted for at least an entire row scan interval.

### CROSS-REFERENCE TO RELATED APPLICATIONS

This application is based on Japanese Patent Application No. 2010-252213 filed on Nov. 10, 2010, the contents of which are hereby incorporated by reference.

### BACKGROUND OF THE INVENTION

1. Field of the Invention

The present invention relates to a liquid crystal display panel, a liquid crystal drive device for driving the liquid crystal display panel, and a liquid crystal display device that uses the liquid crystal display panel and the liquid crystal drive device.

2. Description of Related Art

A scheme for driving liquid crystal display panels that has come to be extensively used over the past several years is a dot inversion drive scheme in which the polarity (positive/negative) of voltage to be applied to the liquid crystal pixels is inverted for each dot.

FIGS. 13 and 14 are block diagrams showing a liquid crystal display device of a first conventional example (without a multiplexer) and a second conventional example (with a multiplexer), respectively. In both conventional examples, the liquid crystal display panel 300 has m gate lines G(1) to G(m), n source lines S(1) to S(n), and (m×n) liquid crystal pixels (the portion enclosed by a square frame with rounded corners; wherein m≧2 and n≧2).

The unshaded liquid crystal pixels show that the voltage applied thereto is of positive polarity (POS) in a k^{th} frame interval, and the shaded liquid crystal pixels show that the voltage applied thereto is of negative polarity (NEG) in the k^{th} frame interval. In the liquid crystal display panel 300, the polarity of the voltage to be applied to the liquid crystal pixels is essentially inverted for each dot. However, when liquid crystal pixels of each of the columns are viewed more closely, the polarity of the voltage to be applied to each pixel is inverted each time two of the gate lines G(1) to G(m) are scanned. In other words, FIGS. 13 and 14 depict the appearance of the liquid crystal display panel 300 being driven by a “two-dot inversion drive scheme.”

An example of prior art related to the above is Japanese Laid-open Patent Application No. 5-48056.

It is true that blinking (flicker) can be reduced in a liquid crystal display panel by using the dot inversion drive scheme as the scheme for driving a liquid crystal display panel.

However, in the liquid crystal display panel 300 of the first and second conventional examples, all of the liquid crystal pixels of the y^{th} column (1≦y≦n) are connected to the source line S(y) of the y^{th} column. Therefore, the polarity of the voltage to be applied to the source lines S(1) to S(n) is inverted each time two gate lines G(1) to G(m) are scanned when the two-dot inversion driving is carried out (see reference symbol A of FIGS. 15 and 16). When such polarity inversion occurs, the capacitative constituents (pixel capacitance, auxiliary capacitance, and wiring capacitance) connected to each of the source lines S(1) to S(n) must be charged from positive to negative or from negative to positive, and a considerable amount of power is lost.

In the liquid crystal display panel 300 of the second conventional example, the voltage to be applied to the (n/3) driver output lines S′(1) to S′(z) is distributed to n source lines S(1) to S(n) by z multiplexers MUX(1) to (z) (1≦z≦(n/3)). Therefore, the polarity of the voltage to be applied the driver output lines S′(1) to S′(z) is inverted at least once per cycle during the voltage distribution process of each row (see reference symbol B of FIG. 16). When such polarity inversion occurs, a capacitative constituent (wiring capacitance) connected to each of the driver output lines S′(1) to S′(z) must be charged from positive to negative or from negative to positive, and power, albeit a small amount, is lost.

There has conventionally been used a method in which charge is shared during polarity inversion in order to reduce the loss of power described above (a method for driving a single source line at three voltage levels (POS, NEG, GND). However, there is a need for greater reduction in power loss in the field of small liquid crystal display devices mounted in, e.g., mobile telephones, mobile game devices, personal digital/data assistants (PDAs), and car audio, in which a battery is used as a power source.

### SUMMARY OF THE INVENTION

In view of these problems found by the present inventors, an object of the present invention is to provide a liquid crystal display panel that can reduce power loss during dot inversion driving, a liquid crystal drive device for driving the liquid crystal display panel, and a liquid crystal display device that uses the liquid crystal display panel and the liquid crystal drive device.

In order to achieve the objects stated above, the liquid crystal display panel according to the present invention comprises a plurality of gate lines, a plurality of source lines, and a plurality of liquid crystal pixels, wherein the plurality of source lines and the plurality of liquid crystal pixels are laid out so that the polarity of voltage to be applied to the plurality of liquid crystal pixels is inverted for individual dots for the liquid crystal display panel overall, and so that the polarity of voltage to be applied to the plurality of source lines is not inverted for at least an entire row scan interval.

Further features, elements, steps, advantages, and characteristics of the present invention will become apparent from the description of preferred embodiments given below and from the attached drawings related to the preferred embodiments.

### BRIEF DESCRIPTION OF THE DRAWINGS

FIG. 1 is a block diagram showing a first embodiment of the liquid crystal display device according to the present invention;

FIG. 2 is a timing chart for describing the liquid crystal drive process of the first embodiment;

FIG. 3 is a data table for describing the data display process of the first embodiment;

FIG. 4 is a block diagram showing a second embodiment of the liquid crystal display device according to the present invention;

FIG. 5 is a timing chart for describing the liquid crystal drive process of the second embodiment;

FIG. 6 is a data table for describing the data display process of the second embodiment;

FIG. 7 is a block diagram showing a third embodiment of the liquid crystal display device according to the present invention;

FIG. 8 is a timing chart for describing the liquid crystal drive process of the third embodiment;

FIG. 9 is a data table for describing the data display process of the third embodiment;

FIG. 10 is a block diagram showing a fourth embodiment of the liquid crystal display device according to the present invention;

FIG. 11 is a timing chart for describing the liquid crystal drive process of the fourth embodiment;

FIG. 12 is a data table for describing the data display process of the fourth embodiment;

FIG. 13 is a block diagram showing a first conventional example of a liquid crystal display device;

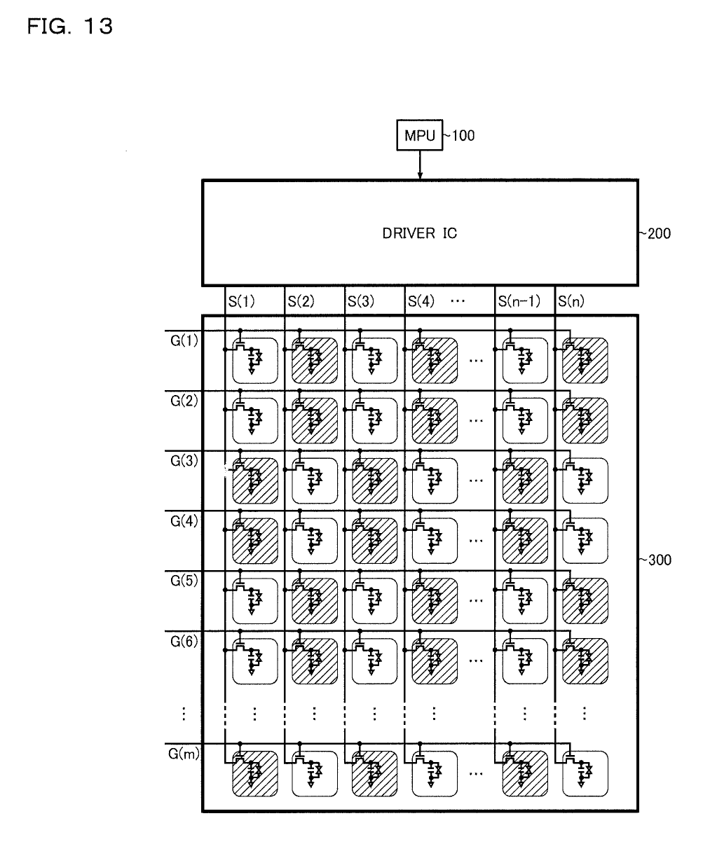

FIG. 14 is a block diagram showing a second conventional example of a liquid crystal display device;

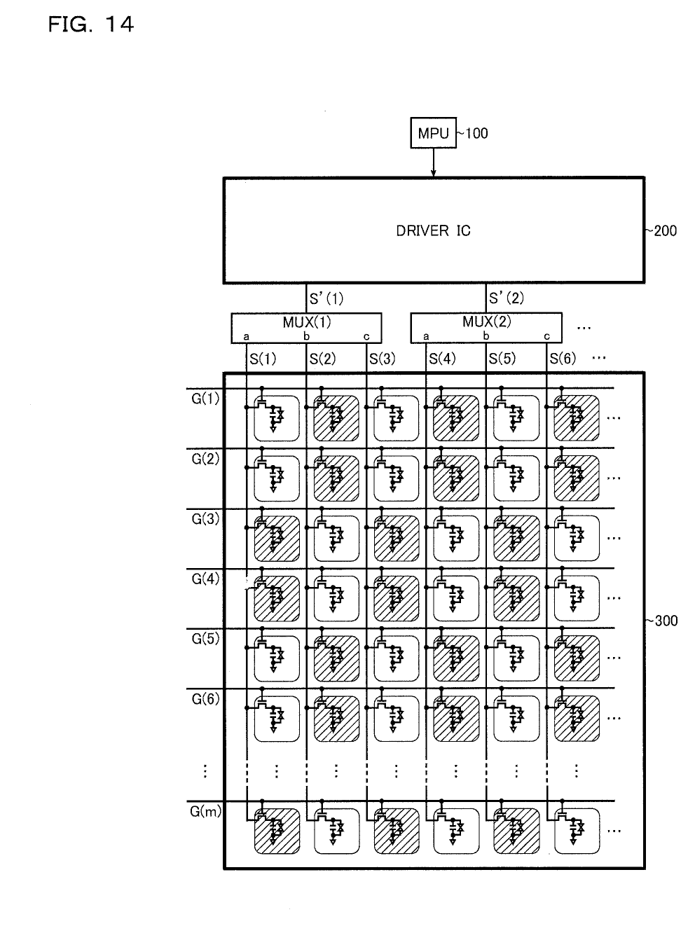

FIG. 15 is a timing chart for describing the liquid crystal drive process of the first conventional example; and

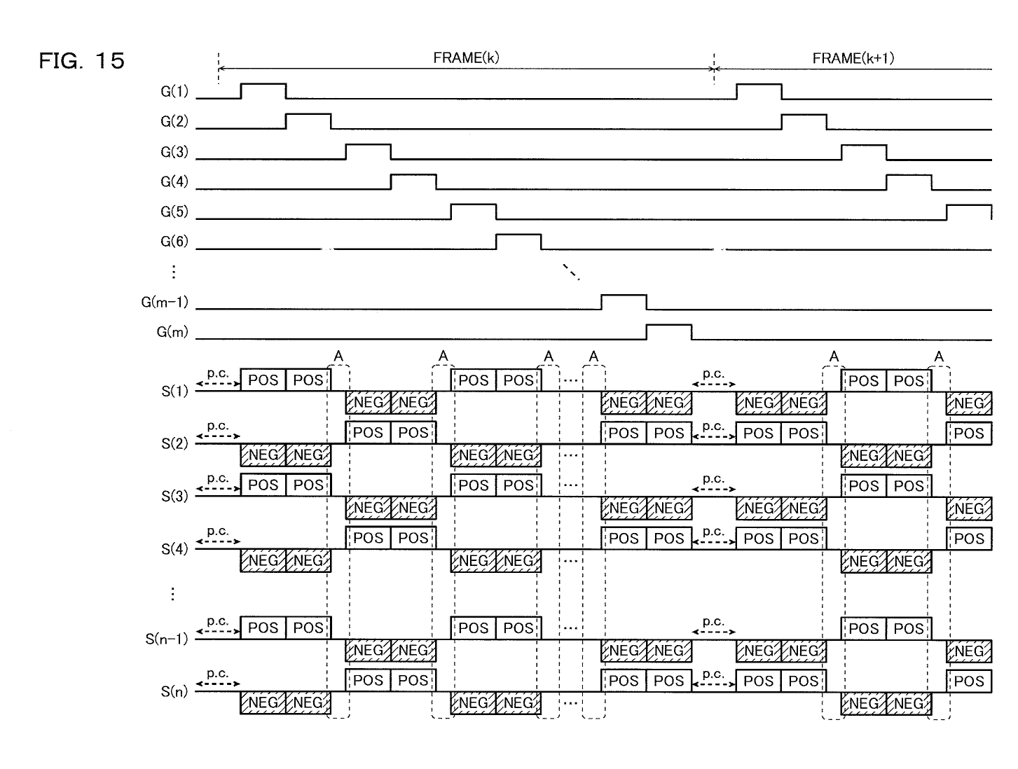

FIG. 16 is a timing chart for describing the liquid crystal drive process of the second conventional example.

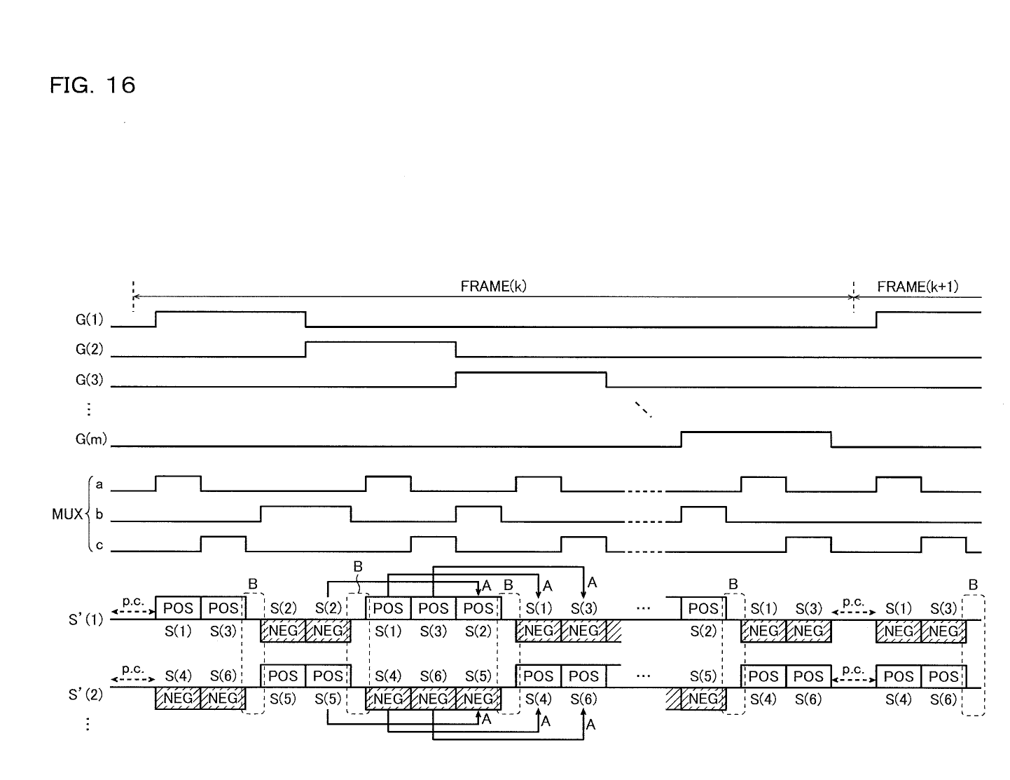

### DETAILED DESCRIPTION OF PREFERRED EMBODIMENTS

### First Embodiment

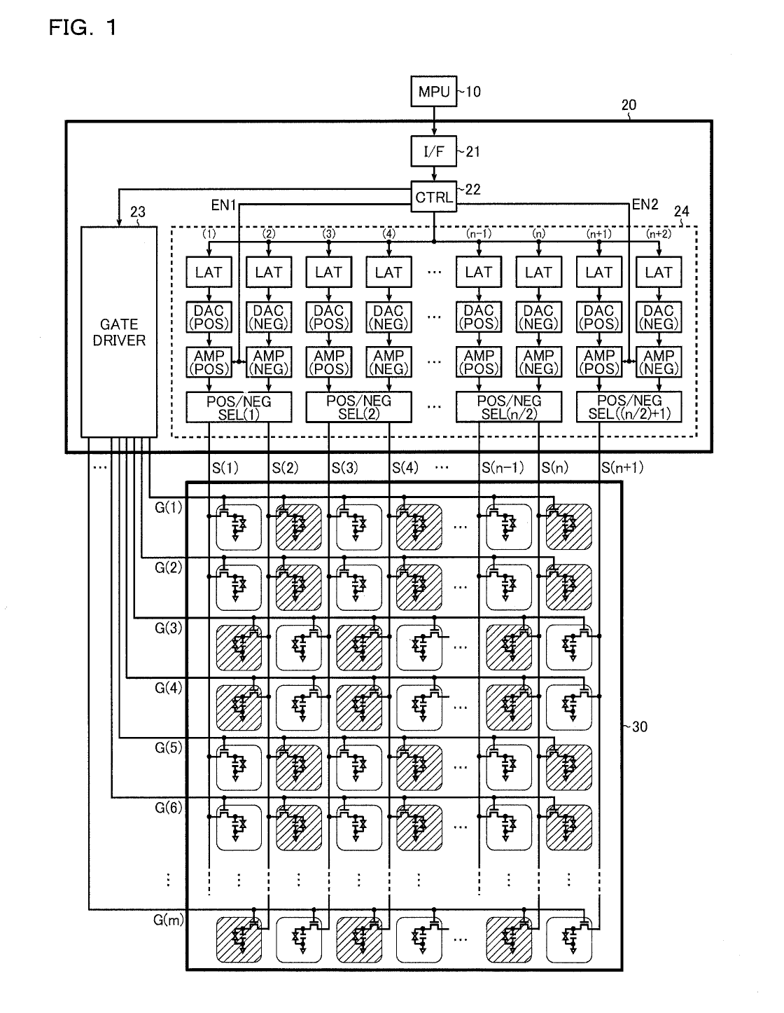

FIG. 1 is a block diagram showing a first embodiment of the liquid crystal display device according to the present invention. The liquid crystal display device of the first embodiment has a micro-processing unit (MPU) 10, a driver IC (liquid crystal drive device) 20, and a liquid crystal display panel 30

The MPU 10 controls the overall operation of the entire liquid crystal display device. In particular, the MPU 10 outputs display data to the driver IC 20 as an operation related to the present invention.

The driver IC 20 is a semiconductor device in which an interface 21, a controller 22, a gate driver 23, and a source driver 24 are integrated. The driver IC 20 drives the liquid crystal display panel 30 using the two-dot inversion driving scheme.

The interface 21 transmits display data from the MPU 10 to the controller 22.

The controller 22 receives the display data from the MPU 10 and carries out various data display processes (a display data rearrangement process, and the like) and various timing controls (row scanning timing control of the gate driver 23, and other controls). The controller 22 generates a first enable signal EN1 and a second enable signal EN2, and outputs these signals to the source driver 24. The operation of the controller 22 is later described in detail.

The gate driver 23 generates an m-system gate signal (m≧2) on the basis of an instruction from the controller 22, and outputs this m-system gate signal to the gate lines G(1) to G(m) of the liquid crystal display panel 30.

The source driver 24 generates an (n+1)-system source signal (n≧2) on the basis of an instruction from the controller 22, and outputs this (n+1)-system source signal to the source lines S(1) to S(n) of the liquid crystal display panel 30.

The source driver 24 includes latches LAT(1) to LAT(n+2), digital/analog converters DAC(1) to DAC(n+2), buffer amplifiers AMP(1) to AMP(n+2), and selectors SEL(1) to SEL((n/2)+1).

The latches LAT(1) to LAT(n+2) temporarily store display data inputted from the controller 22, and outputs the display data to the digital/analog converters DAC(1) to DAC(n+2), respectively.

The digital/analog converters DAC(1) to DAC(n+2) convert digital display data inputted from the latches LAT(1) to LAT(n+2) into analog voltage, and output the analog voltage to the buffer amplifiers AMP(1) to AMP(n+2), respectively. The digital/analog converters DAC(1), DAC(3), . . . , DAC(n−1), DAC(n+1) of odd-numbered columns are all positive output (POS), and the digital/analog converters DAC(2), DAC(4), . . . , DAC(n), DAC(n+2) of even-numbered columns are all negative output (NEG).

The buffer amplifiers AMP(1) to AMP(n+2) buffer the analog voltage inputted from the digital/analog converters DAC(1) to DAC(n+2), and output the analog voltage to the selectors SEL(1) to SEL((n/2)+1), respectively. The buffer amplifiers AMP(1), AMP(3), . . . , AMP(n−1), AMP(n+1) of odd-numbered columns are all positive output (POS), and the buffer amplifiers AMP(2), AMP(4), . . . , AMP(n), AMP(n+2) of even-numbered columns are all negative output (NEG). Each of the buffer amplifiers AMP(1) and AMP(2) is controlled to an on or off state by the first enable signal EN1, and each the buffer amplifiers AMP(n+1) and AMP(n+2) is controlled to an on or off state by the second enable signal EN2.

The selector SEL(1) switches between a first state in which the positive output of the buffer amplifier AMP(1) is applied to the source line S(1) of the first column and the negative output of the buffer amplifier AMP(2) is applied to the source line S(2) of the second column, and a second state, which is opposite that of the first state, in which the positive output of the buffer amplifier AMP(1) is applied to the source line S(2) of the second column and the negative output of the buffer amplifier AMP(2) is applied to the source line S(1) of the first column. The switching operation of the selectors SEL(2) to SEL(n/2) is also essentially the same as that described above. On the other hand, since the source line S(n+2) of the (n+2)^{th} column does not exist, the switching operation of the selector SEL((n/2)+1) switches between a first state in which the positive output of the buffer amplifier AMP(n+1) is applied to the source line S(n+1) of the (n+1)^{th} column, and a second state in which the negative output of the buffer amplifier AMP(n+2) is applied to the source line S(n+1) of the (n+1)^{th} column.

The operation of the source driver 24 as constituted above will be later described with specific examples.

The liquid crystal display panel 30 has m gate lines G(1) to G(m), (n+1) source lines S(1) to S(n+1) orthogonal thereto, and (m×n) liquid crystal pixels (the portion enclosed by a square frame with rounded corners).

The unshaded liquid crystal pixels show that the voltage applied thereto is of positive polarity (POS) in a k^{th} frame interval, and the shaded liquid crystal pixels show that the voltage applied thereto is of negative polarity (NEG) in the k^{th} frame interval. In the liquid crystal display panel 30, the polarity of the voltage to be applied to the liquid crystal pixels is essentially inverted for each dot. However, when liquid crystal pixels of each column are viewed more closely, the polarity of the voltage to be applied to each pixel is inverted each time two of the gate lines G(1) to G(m) are scanned. In other words, FIG. 1 depicts the appearance of the liquid crystal display panel 30 being driven by a so-called two-dot inversion drive scheme.

A liquid crystal element, an auxiliary capacitative element, and a thin film transistor (TFT) as an active element are incorporated in each liquid crystal pixel. The gate of the thin film transistor is connected to any of the gate lines G(1) to G(m). The source of the thin film transistor is connected to any of the source lines S(1) to S(n+1). The drain of the thin film transistor is connected to one end of the corresponding liquid crystal element and auxiliary capacitative element. The other ends of the liquid crystal element and auxiliary capacitative element are both connected to a common voltage application terminal.

An amorphous silicon (AMO)-type thin film transistor can be advantageously used in the liquid crystal display device of the first embodiment. However, the configuration of the present invention is not limited thereby, it also being possible to use a high-temperature polysilicon-type (HTPS-type) thin film transistor or a low-temperature polysilicon-type (LTPS-type) thin film transistor.

A characterizing configuration of the liquid crystal display panel 30 is one in which liquid crystal pixels in the first column are connected to the source line S(1) of the first column in the row scanning direction every x number of rows (1≧x≧(m/2)) while intervals of x number of rows are skipped. More specifically, in accordance with the example of FIG. 1, and with respect to the source line S(1) of the first column in the row scanning direction, there are first connected two rows (first and second rows) of the liquid crystal pixels of the first column, and there are next connected another two rows (fifth and sixth rows) of the liquid crystal pixels of the first column, An interval of two rows (third and fourth rows) being skipped. The same applies to the seventh row and thereafter (not shown).

The liquid crystal pixels in the y^{th} column and the liquid crystal pixels in the (y−1)^{th} column are connected to the source line S(y) of the y^{th} column (2≦y≦n) in alternating fashion in the row scanning direction every x number of rows. More specifically, in accordance with in the example of FIG. 1, with respect to the source line S(2) of the second column in the row scanning direction there are first connected two rows (first and second rows) of the liquid crystal pixels of the second column, there are subsequently connected two rows (third and fourth rows) of the liquid crystal pixels of the first column, and there are next connected two rows (fifth and sixth rows) of the liquid crystal pixels of the second column. In other words, the liquid crystal pixels of the first column and the liquid crystal pixels of the second column are connected to the source line S(2) of the second column in an alternating fashion (in a staggered fashion) in a state of left/right inversion (mirroring) having the source line S(2) of the second column as the axis of symmetry. The same applies to the seventh row and thereafter (not shown), and likewise to the source lines S(3) to S(n).

Further, x number of rows of liquid crystal pixels of the n^{th} column are connected to the source line S(n+1) of the (n+1)^{th} column in the row scanning direction while intervals of x number of rows are skipped. More specifically, in accordance with in the example of FIG. 1, first, with respect to the source line S(n+1) of the (n+1)^{th} column, an interval of two rows (first and second rows) in the row scanning direction is skipped, after which two rows (third and fourth rows) of the liquid crystal pixels of the n^{th} column are connected, and then two rows (fifth and sixth rows) are skipped. The same applies to the seventh row and thereafter (not shown).

In a liquid crystal display panel 30 in which liquid crystal pixels are arrayed in the manner described above, the polarity of the voltage to be applied to the source lines S(1) to S(n) is no longer inverted during at least a single frame interval in the case of two-dot inversion driving. Therefore, the capacitative constituents (pixel capacitance, auxiliary capacitance, and wiring capacitance) connected to each of the source lines S(1) to S(n) are no longer required be charged from positive to negative or from negative to positive, and power loss can be considerably reduced.

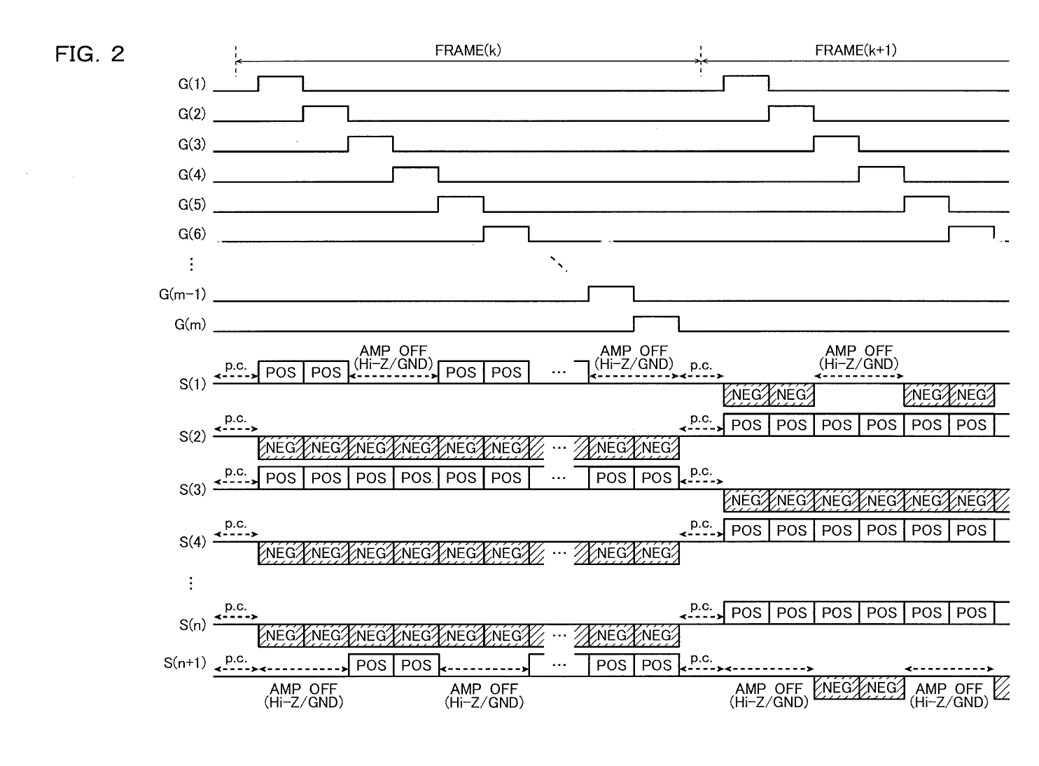

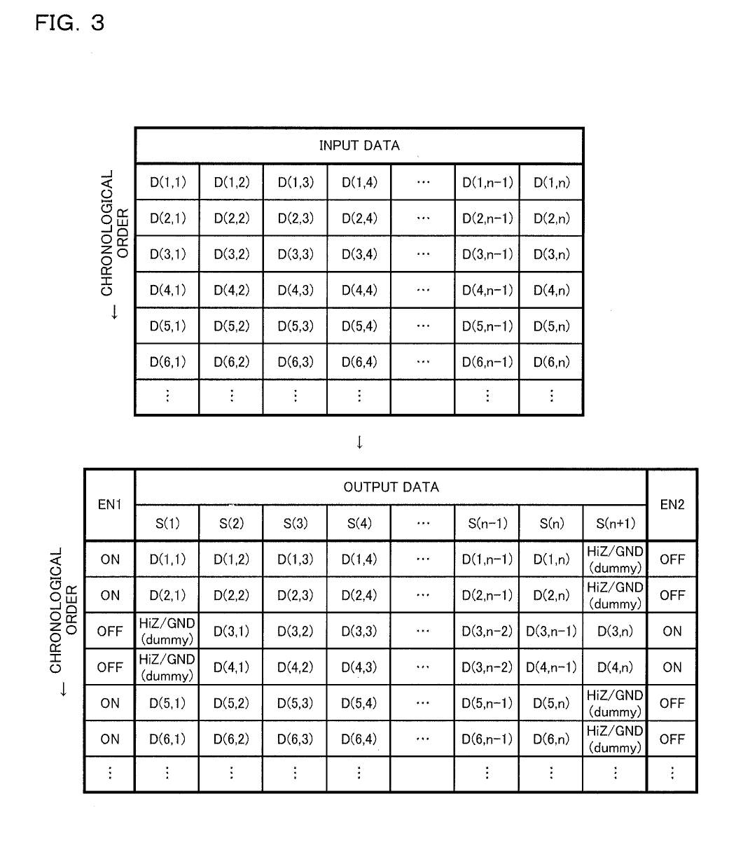

FIG. 2 is a timing chart for describing the liquid crystal drive process of the first embodiment, and depicts a state in which voltage is applied to the gate lines G(1) to G(m) and the source lines S(1) to S(n+1) in sequence from the top. FIG. 3 is a data table for describing the data display process of the first embodiment (upper table: input data; lower table: output data (S(1) to S(n+1), EN1, EN2). In FIG. 2, “p.c.” represents a pre-charge interval, and in FIG. 3, the expression D(i, j) (1≦i≦m, 1≦j≦(n+1)) represents display data (or the voltage value that corresponds thereto) for a liquid crystal pixel positioned at the coordinate (i, j).

In the k^{th} frame interval FRAME(k), POS voltages (D(1, 1), D(1, 3), . . . , D(1, n−1)) are applied to the source lines S(1), S(3), . . . , S(n−1) and NEG voltages (D(1, 2), D(1, 4), . . . , D(1, n) are applied to the source lines S(2), S(4), . . . , S(n) in the first row selection interval (G(1)=H). POS voltages (D(2, 1), D(2, 3), . . . , D(2, n−1)) are applied to the source lines S(1), S(3), S(n−1) and NEG voltages (D(2, 2), D(2, 4), . . . , D(2, n)) are applied to the source lines S(2), S(4), . . . , S(n) in the subsequent second row selection interval (G(2)=H).

Since the first and second rows of liquid crystal pixels are not connected to the source line S(n+1), voltage is not required to be applied to the source line S(n+1) in the first and second row selection intervals. In view thereof, the controller 22 generates a first enable signal EN1 and a second enable signal EN2 so that the amplifiers AMP(1), AMP(2) connected to the source line S(1) are switched on and so that the amplifiers AMP(n+1), AMP(n+2) connected to the source line S(n+1) are switched off in the first and second row selection intervals. Such a configuration makes it possible to avoid unnecessary power consumption by the source driver 24. The source line S(n+1) is at Hi-Z (high impedance) or GND while the amplifiers AMP(n+1), AMP(n+2) are switched off. At this time, the content of the display data inputted to the amplifiers AMP(n+1), AMP(n+2) can be ignored, and any dummy data can be inputted.

POS voltages (D(3, 2), D(3, 4), . . . , D(3, n)) are applied to the source lines S(3), S(5), . . . , S(n+1) and NEG voltages (D(3, 1), D(3, 3), . . . , D(3, n−1)) are applied to the source lines S(2), S(4), . . . , S(n) in the third row selection interval (G(3)=H). POS voltages (D(4, 2), D(4, 4), . . . , D(4, n)) are applied to the source lines S(3), S(5), . . . , S(n+1) and NEG voltages (D(4, 1), D(4, 3), . . . , D(4, n−1) are applied to the source lines S(2), S(4), . . . , S(n) in the fourth row selection interval (G(4)=H).

Since the third and fourth row liquid crystal pixels are not connected to the source line S(1) of the first column, voltage is not required to be applied to the source line S(1) in the third and fourth row selection intervals. In view thereof, the controller 22 generates a first enable signal EN1 and a second enable signal EN2 so that the amplifiers AMP(1), AMP(2) connected to the source line S(1) are switched off and so that the amplifiers AMP(n+1), AMP(n+2) connected to the source line S(n+1) are switched on in the third and fourth row selection intervals. Such a configuration makes it possible to avoid unnecessary power consumption by the source driver 24. The source line S(1) is at Hi-Z (high impedance) or GND while the amplifiers AMP(1), AMP(2) are switched off. At this time, the content of the display data inputted to the amplifiers AMP(1), AMP(2) can be ignored, and any dummy data can be inputted.

The liquid crystal drive process and the data display process are carried out in the same manner as described above for the fifth to m rows. Also, the liquid crystal drive process and the data display process are carried out in the same manner as described above in the (k+1)^{th} frame interval FRAME(k+1) after the positive polarity and negative polarity have been inverted.

As described above, with such a configuration, the polarity of the voltage to be applied to the source lines S(1) to S(n) is no longer inverted during at least a single frame interval in the case of two-dot inversion driving of the liquid crystal display panel 30. Therefore, the capacitative constituents (pixel capacitance, auxiliary capacitance, and wiring capacitance) connected to each of the source lines S(1) to S(n) are no longer required be charged from positive to negative or from negative to positive, and power loss can be considerably reduced.

### Second Embodiment

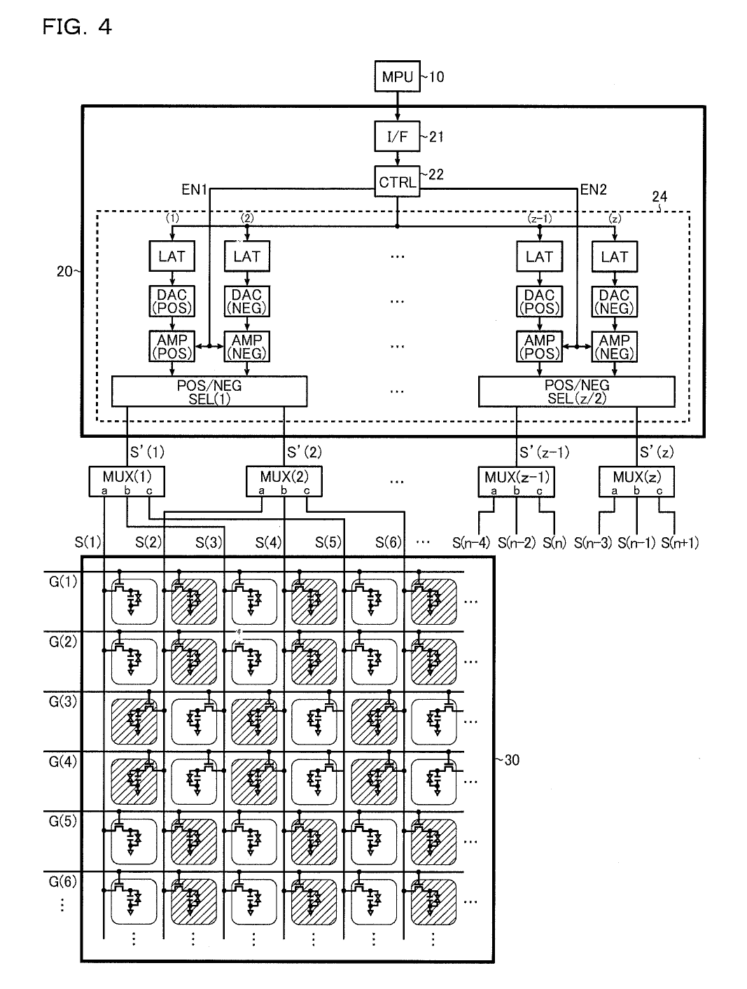

FIG. 4 is a block diagram showing a second embodiment of the liquid crystal display device according to the present invention. The liquid crystal display device of the second embodiment has essentially the same configuration as the first embodiment described above, except for additionally having multiplexers MUX(1) to MUX(z) for distributing the voltage applied to the driver output lines S′(1) to S′(z) (1≦z≦(n+1)/3) of the driver IC 20 to three systems to supply the voltage to the source lines S(1) to S(n+1) of the liquid crystal display panel 30; and additionally, slight modification is made to the internal configuration and operation of the source driver 24. In view thereof, the same reference symbols as FIG. 1 are used for the constituent portions that are the same as the first embodiment and a redundant description thereof is omitted. The following description is provided with emphasis on the feature portions of the second embodiment.

The source driver 24 includes latches LAT(1) to LAT(z), digital/analog converters DAC(1) to DAC(z), buffer amplifiers AMP(1) to AMP(z), and selectors SEL(1) to SEL(z/2).

The latches LAT(1) to LAT(z) temporarily stores display data inputted from the controller 22 and outputs [the display data] to the digital/analog converters DAC(1) to DAC(z), respectively.

The digital/analog converters DAC(1) to DAC(z) convert digital display data inputted from the latches LAT(1) to LAT(z) into analog voltage, and output the analog voltage to the buffer amplifiers AMP(1) to AMP(z), respectively. The digital/analog converters DAC(1), DAC(3), . . . , DAC(z−1), of odd-numbered columns are all positive output (POS), and the digital/analog converters DAC(2), DAC(4), . . . , DAC(z), of even-numbered columns are all negative output (NEG).

The buffer amplifiers AMP(1) to AMP(z) buffer the analog voltage inputted from the digital/analog converters DAC(1) to DAC(z), and output the analog voltage to the selectors SEL(1) to SEL(z/2), respectively. The buffer amplifiers AMP(1), AMP(3), . . . , AMP(z−1), of odd-numbered columns are all positive output (POS), and the buffer amplifiers AMP(2), AMP(4), . . . , AMP(z), of even-numbered columns are all negative output (NEG). Each of the buffer amplifiers AMP(1) and AMP(2) is controlled in an on or off state by the first enable signal EN1, and each of the buffer amplifiers AMP(z−1) and AMP(z) is controlled in an on or off state by the second enable signal EN2.

The selector SEL(1) switches between a first state in which the positive output of the buffer amplifier AMP(1) is applied to the driver output line S′(1) and the negative output of the buffer amplifier AMP(2) is applied to the driver output line S′(2), and a second state, which is opposite that of the first state, in which the positive output of the buffer amplifier AMP(1) is applied to the driver output line S′(2) and the negative output of the buffer amplifier AMP(2) is applied to the driver output line S′(1). The switching operation of the selectors SEL(2) to SEL(z/2) is also essentially the same as that described above.

The multiplexer MUX(1) distributes and outputs to the source lines S(1), S(3), S(5) the voltage applied to the driver output line S′(1). The multiplexer MUX(2) distributes and outputs to the source lines S(2), S(4), S(6) the voltage applied to the driver output line S′(2). The voltage distribution process of the multiplexers MUX(3) to MUX(z) is essentially the same as that described above.

The liquid crystal display panel 30 has exactly the same configuration as that of the first embodiment described above. Therefore, the polarity of the voltage to be applied to the source lines S(1) to S(n) is no longer inverted during at least a single frame interval in the case of two-dot inversion driving. Therefore, the capacitative constituents (pixel capacitance, auxiliary capacitance, and wiring capacitance) connected to each of the source lines S(1) to S(n) are no longer required be charged from positive to negative or from negative to positive, and power loss can be considerably reduced.

The multiplexers MUX(1) to MUX(z) are connected to the source lines of three systems to which voltage of the same polarity is applied. Therefore, the polarity of the voltage applied to the driver output lines S′(1) to S′(z) is not inverted even when voltage distribution processing is carried out in the multiplexers MUX(1) to MUX(z) in each row selection interval.

A high-temperature polysilicon-type (HTPS-type) thin film transistor or a low-temperature polysilicon-type (LTPS-type) thin film transistor can be used advantageously in the liquid crystal display device of the second embodiment. However, the configuration of the present invention is not limited thereby, and it is also possible to use an amorphous silicon (AMO)-type thin film transistor.

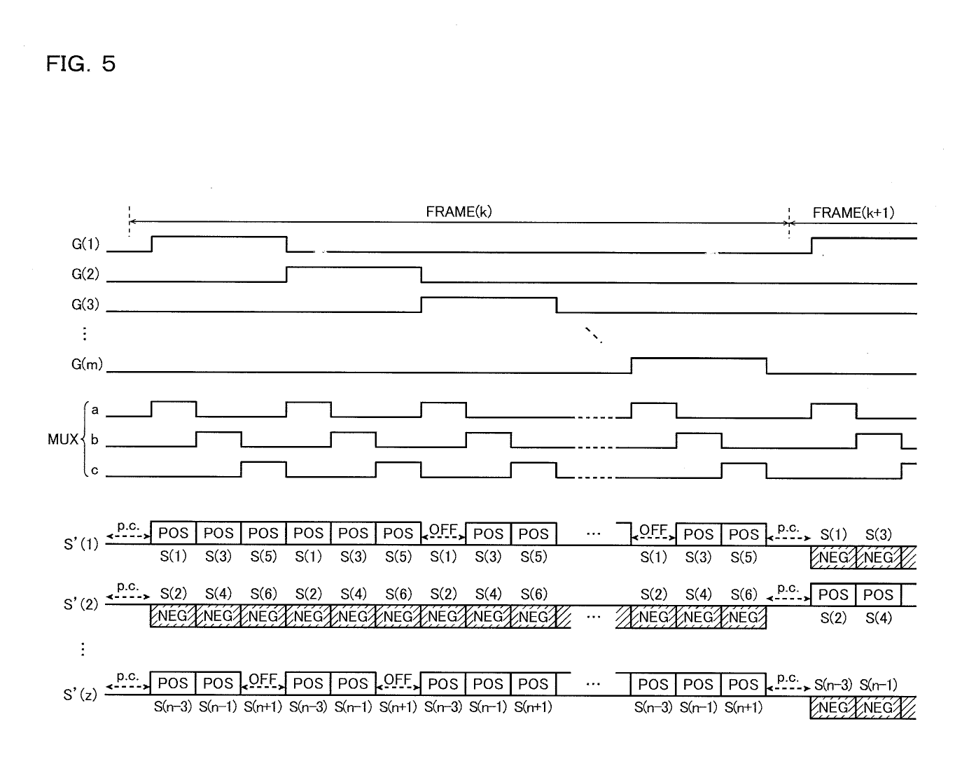

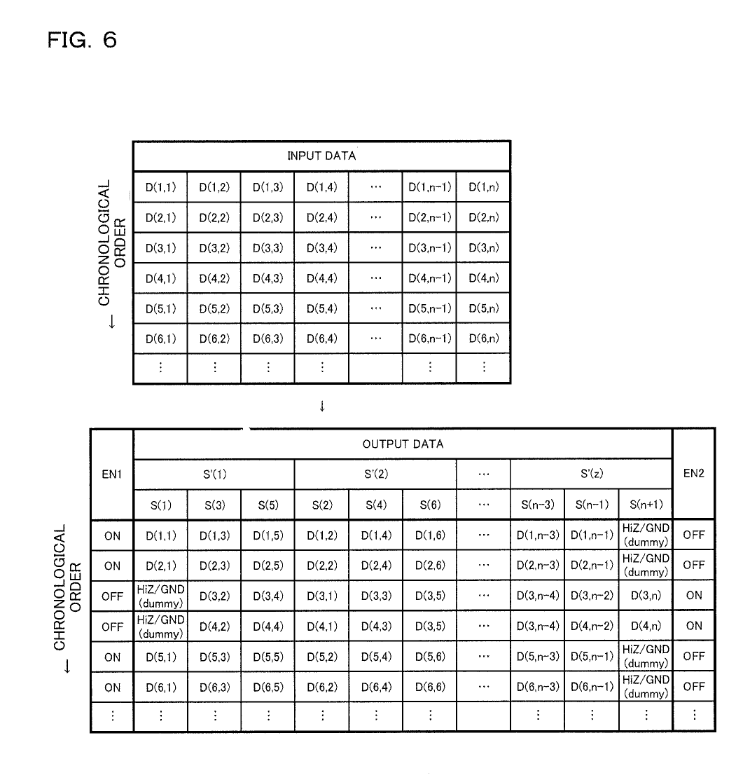

FIG. 5 is a timing chart for describing the liquid crystal drive process of the second embodiment, and depicts a state in which voltage is applied to the gate lines G(1) to G(m), MUX switching control signals a to c, and the driver output lines S′(1) to S′(z) in sequence from the top. FIG. 6 is a data table for describing the data display process of the second embodiment (upper table: input data; lower table: output data (S(1) to S(n+1), EN1, EN2). In FIG. 5, “p.c.” represents a pre-charge interval, and in FIG. 6, the expression D(i, j) (1≦i≦m, 1≦j≦(n+1)) represents display data (or the voltage value that corresponds thereto) for a liquid crystal pixel positioned at the coordinate (i, j).

In the k^{th} frame interval FRAME(k), the MUX switching control signals a to c are sequentially set to a high level in time-sharing fashion for each row selection interval. In the case of the driver output line S′(1), a POS voltage for the source line S(1) is applied during the a-system selection interval (a=H); a POS voltage for the source line S(3) is applied during the b-system selection interval (b=H); and a POS voltage for the source line S(5) is applied during the c-system selection interval (c=H). In the case of the driver output line S′(2), a NEG voltage for the source line S(2) is applied during the a-system selection interval (a=H); a NEG voltage for the source line S(4) is applied during the b-system selection interval (b=H); and a NEG voltage for the source line S(6) is applied during the c-system selection interval (c=H). The other driver output lines S′(3) to S′(z) are also essentially the same as those described above. The operation for generating the first enable signal EN1 and second enable signal EN2 is also the same as the first embodiment described above.

In this manner, in accordance with the liquid crystal display device of the second embodiment, the same effect as that of the first embodiment can be obtained, and the number of output systems of the source driver 24 can be reduced using the multiplexers MUX(1) to MUX(z).

### Third Embodiment

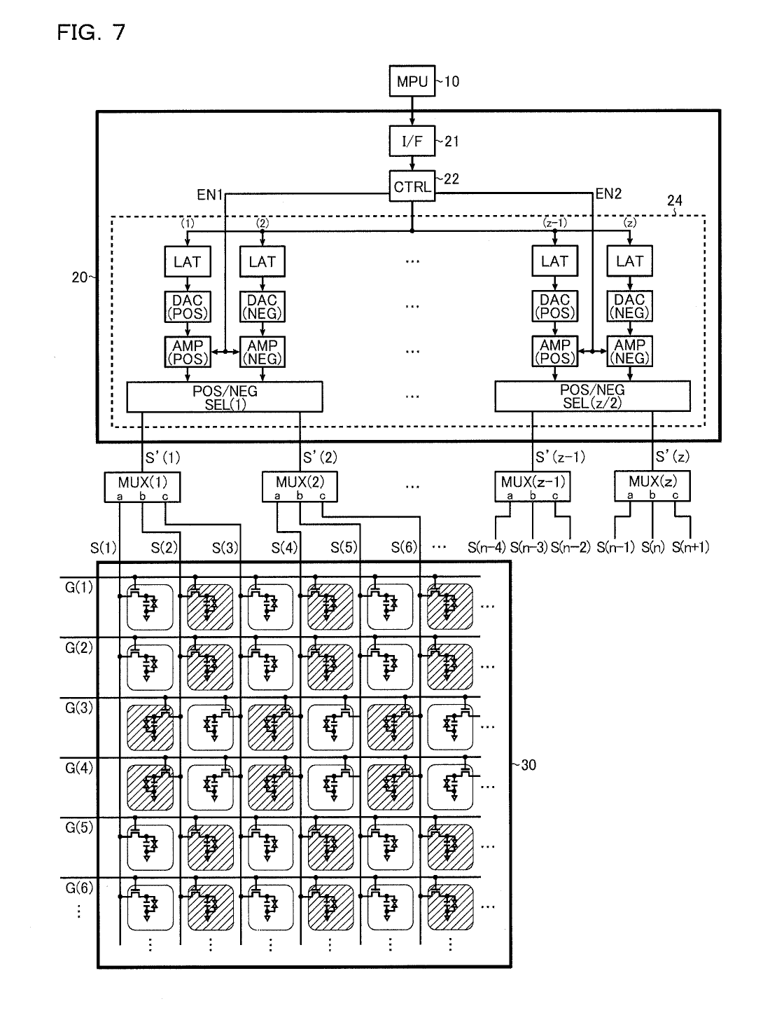

FIG. 7 is a block diagram showing a third embodiment of the liquid crystal display device according to the present invention. The liquid crystal display device of the third embodiment has essentially the same configuration as the second embodiment described above, except for modifications made to the voltage distribution process and the output destination of the multiplexers MUX(1) to MUX(z). In view thereof, the same reference symbols as FIG. 4 are used for the constituent portions that are the same as the second embodiment and a redundant description thereof is omitted. The following description is provided with emphasis on the feature portions of the third embodiment.

The multiplexer MUX(1) distributes and outputs to the source lines S(1), S(2), S(3) the voltage applied to the driver output line S′(1). The multiplexer MUX(2) distributes and outputs to the source lines S(4), S(5), S(6) the voltage applied to the driver output line S′(2). The voltage distribution process of the multiplexers MUX(3) to MUX(z) is essentially the same as that described above.

The liquid crystal display panel 30 has exactly the same configuration as that of the first and second embodiments described above. Therefore, the polarity of the voltage to be applied to the source lines S(1) to S(n) is not inverted during at least a single frame interval in the case of two-dot inversion driving. Therefore, the capacitative constituents (pixel capacitance, auxiliary capacitance, and wiring capacitance) connected to each of the source lines S(1) to S(n) are no longer required be charged from positive to negative or from negative to positive, and power loss can be considerably reduced.

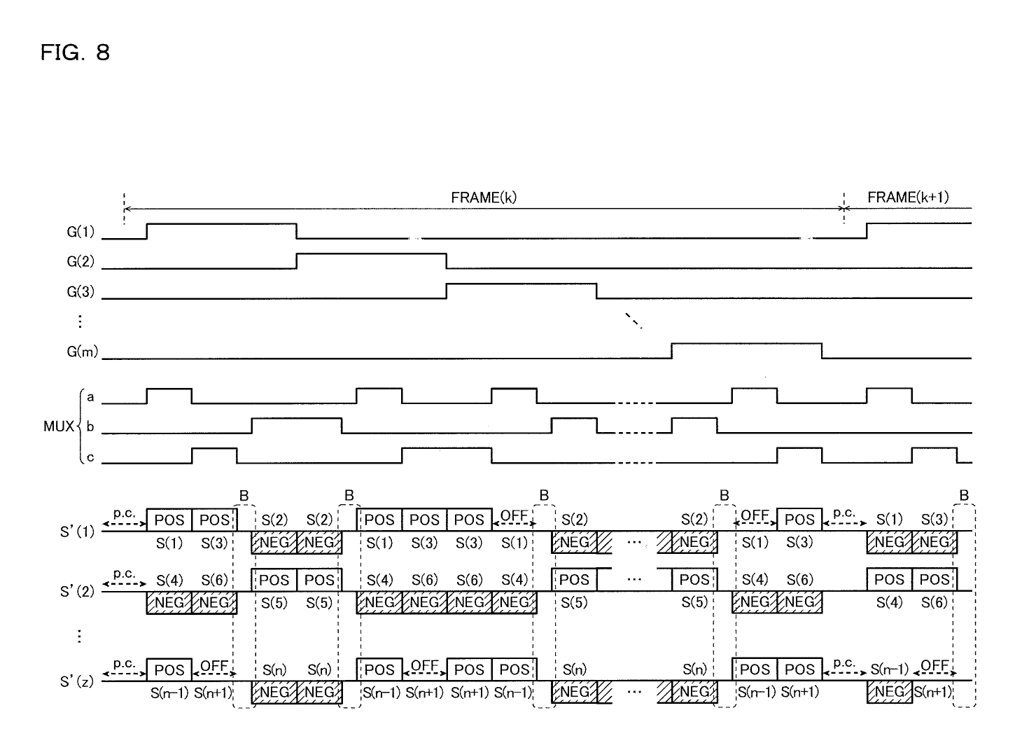

On the other hand, the multiplexers MUX(1) to MUX(z) are connected to the source lines of three consecutive systems, which is different from the second embodiment described above. Therefore, the source lines S(1) to S(n+1) are more easily laid out. However, in a liquid crystal display panel 30 driven by dot inversion, the voltage applied to the source lines of three consecutive systems cannot have exactly the same polarity. It should therefore be noted that the polarity of the voltage applied to the driver output lines S′(1) to S′(z) is not inverted in accompaniment with voltage distribution processing carried out in the multiplexers MUX(1) to MUX(z) in each row selection interval (see reference symbol B of FIG. 8).

A high-temperature polysilicon-type (HTPS-type) thin film transistor or a low-temperature polysilicon-type (LTPS-type) thin film transistor can be used advantageously in the liquid crystal display device of the third embodiment in the same manner as the second embodiment described above. However, the configuration of the present invention is not limited thereby, and it is also possible to use an amorphous silicon (AMO)-type thin film transistor.

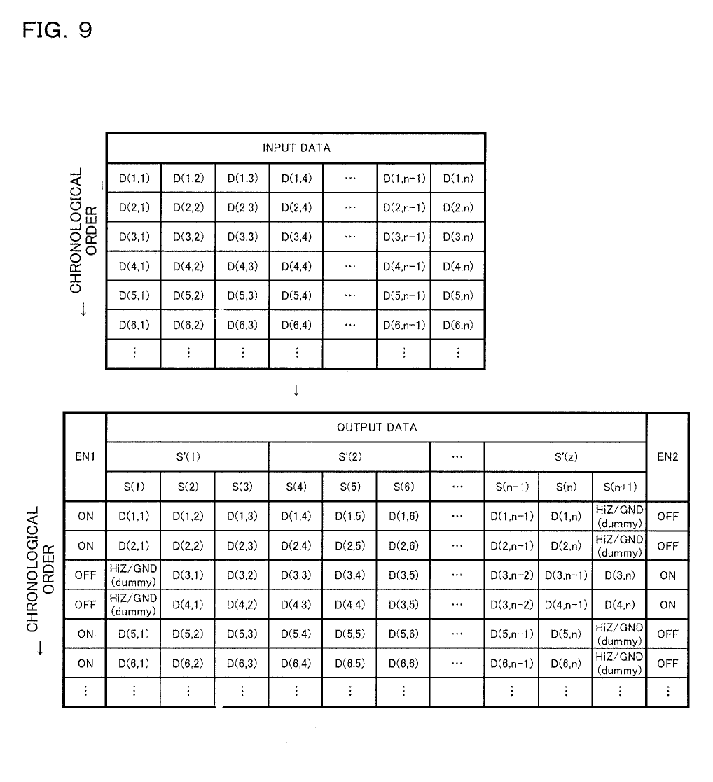

FIG. 8 is a timing chart for describing the liquid crystal drive process of the third embodiment, and depicts a state in which voltage is applied to the gate lines G(1) to G(m), MUX switching control signals a to c, and the driver output lines S′(1) to S′(z) in sequence from the top. FIG. 9 is a data table for describing the data display process of the third embodiment (upper table: input data; lower table: output data (S(1) to S(n+1), EN1, EN2). In FIG. 8, “p.c.” represents a pre-charge interval, and in FIG. 9, the expression D(i, j) (1≦i≦m, 1≦j≦(n+1)) represents display data (or the voltage value that corresponds thereto) for a liquid crystal pixel positioned at the coordinate (i, j).

In the k^{th} frame interval FRAME(k), the MUX switching control signals a to c are sequentially set to a high level in time-sharing fashion for each of the row selection intervals. In the case of the driver output line S′(1), a POS voltage for the source line S(1) is applied during the a-system selection interval (a=H); a NEG voltage for the source line S(2) is applied during the b-system selection interval (b=H); and a POS voltage for the source line S(3) is applied during the c-system selection interval (c=H). In the case of the driver output line S′(2), a NEG voltage for the source line S(4) is applied during the a-system selection interval (a=H); a NEG voltage for the source line S(5) is applied during the b-system selection interval (b=H); and a NEG voltage for the source line S(6) is applied during the c-system selection interval (c=H). The other driver output lines S′(3) to S′(z) are also essentially the same as those described above. The operation for generating the first enable signal EN1 and second enable signal EN2 is also the same as the first and second embodiments described above.

The output system selection sequence of the multiplexers MUX(1) to MUX(z) is preferably rearranged for each row, as shown in FIG. 8, in order to maximally reduce polarity inversion of the voltage applied to the driver output lines S′(1) to S′(z) in accompaniment with voltage distribution processing carried out in the multiplexers MUX(1) to MUX(z).

In this manner, in accordance with the liquid crystal display device of the third embodiment, substantially the same effect as that of the second embodiment can be obtained, and the source lines S(1) to S(n+1) can be more easily laid out.

### Fourth Embodiment

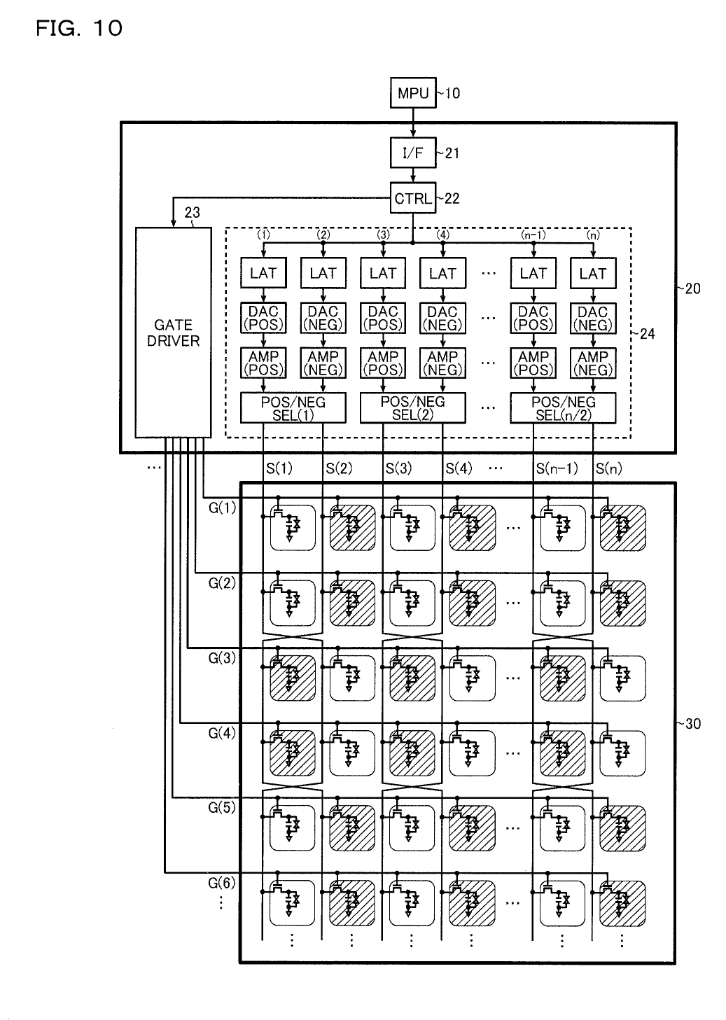

FIG. 10 is a block diagram showing a fourth embodiment of the liquid crystal display device according to the present invention. The liquid crystal display device of the fourth embodiment is based essentially on the same viewpoint as that of the first embodiment described above. However, there are differences in the internal layout of the liquid crystal display panel 30 and modifications have been made to the internal configuration and operation of the source driver 24. In view thereof, the same reference symbols as FIG. 1 are used for the constituent portions that are the same as the first embodiment and a redundant description thereof is omitted. The following description is provided with emphasis on the feature portions of the fourth embodiment.

The source driver 24 includes latches LAT(1) to LAT(n), digital/analog converters DAC(1) to DAC(n), buffer amplifiers AMP(1) to AMP(n), and selectors SEL(1) to SEL(n/2).

The latches LAT(1) to LAT(n+2) temporarily store display data inputted from the controller 22, and output the display data to the digital/analog converters DAC(1) to DAC(n), respectively.

The digital/analog converters DAC(1) to DAC(n) convert digital display data inputted from the latches LAT(1) to LAT(n) into analog voltage, and output the analog voltage to the buffer amplifiers AMP(1) to AMP(n), respectively. The digital/analog converters DAC(1), DAC(3), . . . , DAC(n−1) of odd-numbered columns are all positive output (POS), and the digital/analog converters DAC(2), DAC(4), . . . , DAC(n) of even-numbered columns are all negative output (NEG).

The buffer amplifiers AMP(1) to AMP(n) buffer the analog voltage inputted from the digital/analog converters DAC(1) to DAC(n), and output the analog voltage to the selectors SEL(1) to SEL(n/2), respectively. The buffer amplifiers AMP(1), AMP(3), . . . , AMP(n−1) of odd-numbered columns are all positive output (POS), and the buffer amplifiers AMP(2), AMP(4), . . . , AMP(n) of even-numbered columns are all negative output (NEG).

The selector SEL(1) switches between a first state in which the positive output of the buffer amplifier AMP(1) is applied to the source line S(1) of the first column and the negative output of the buffer amplifier AMP(2) is applied to the source line S(2) of the second column, and a second state, which is opposite that of the first state, in which the positive output of the buffer amplifier AMP(1) is applied to the source line S(2) of the second column and the negative output of the buffer amplifier AMP(2) is applied to the source line S(1) of the first column. The switching operation of the selectors SEL(2) to SEL(n/2) is also essentially the same as that described above.

The liquid crystal display panel 30 has m gate lines G(1) to G(m), n source lines S(1) to S(n) orthogonal thereto, and (m×n) liquid crystal pixels. An amorphous silicon (AMO)-type thin film transistor can be advantageously used in the liquid crystal display device of the fourth embodiment in the same manner as the first embodiment. However, the configuration of the present invention is not limited thereby, and it is also possible to use a high-temperature polysilicon-type (HTPS-type) thin film transistor or a low-temperature polysilicon-type (LTPS-type) thin film transistor.

A characterizing configuration of the liquid crystal display panel 30 is that the liquid crystal pixels of the y^{th} column and the liquid crystal pixels of the (y+1)^{th} column are connected in the row scanning direction to the source line S(y) of the y^{th} column (y=1, 3, 5, . . . , (n−1)) in alternating fashion every x number of rows (1≦x≦(m/2)); the liquid crystal pixels of the (y+1)^{th} column and the liquid crystal pixels of the y^{th} column are connected in the row scanning direction to the source line S of the (y+1)^{th} column in alternating fashion every x number of rows; and the mutual layout positions of the source line of the y^{th} column and the source line of the (y+1)^{th} column are inverted every x rows in the row scanning direction.

More specifically, in accordance with in the example of FIG. 1, first, two rows (first and second rows) of the liquid crystal pixels of the first column are connected in the row scanning direction to the source line S(1) of the first column. Two rows (first and second rows) of the liquid crystal pixels of the second column are connected in the row scanning direction to the source line S(2) of the second column. The layout positions of the source line S(1) and the source line S(2) are mutually inverted between the second and third rows. After the layout positions have been inverted, two rows (third and fourth rows) of the liquid crystal pixels of the second column are connected in the row scanning direction to the source line S(1). Two rows (third and fourth rows) of the liquid crystal pixels of the first column are connected in the row scanning direction to the source line S(2). The layout positions of the source line S(1) and the source line S(2) are again mutually inverted between the fourth and fifth rows. After the layout positions have been inverted again, two rows (fifth and sixth rows) of the liquid crystal pixels of the first column are connected in the row scanning direction to the source line S(1). Furthermore, two rows (fifth and sixth rows) of the liquid crystal pixels of the second column are connected in the row scanning direction to the source line S(2). The same applies to the seventh row and thereafter (not shown), and the same applies to the source lines S(3) to S(n).

In a liquid crystal display panel 30 in which liquid crystal pixels and the source lines S(1) to S(n) are arrayed in the manner described above, the polarity of the voltage to be applied to the source lines S(1) to S(n) is no longer inverted during at least a single frame interval in the case of two-dot inversion driving in the same manner as the first embodiment described above. Therefore, the capacitative constituents (pixel capacitance, auxiliary capacitance, and wiring capacitance) connected to each of the source lines S(1) to S(n) are no longer required to be charged from positive to negative or from negative to positive, and power loss can be considerably reduced.

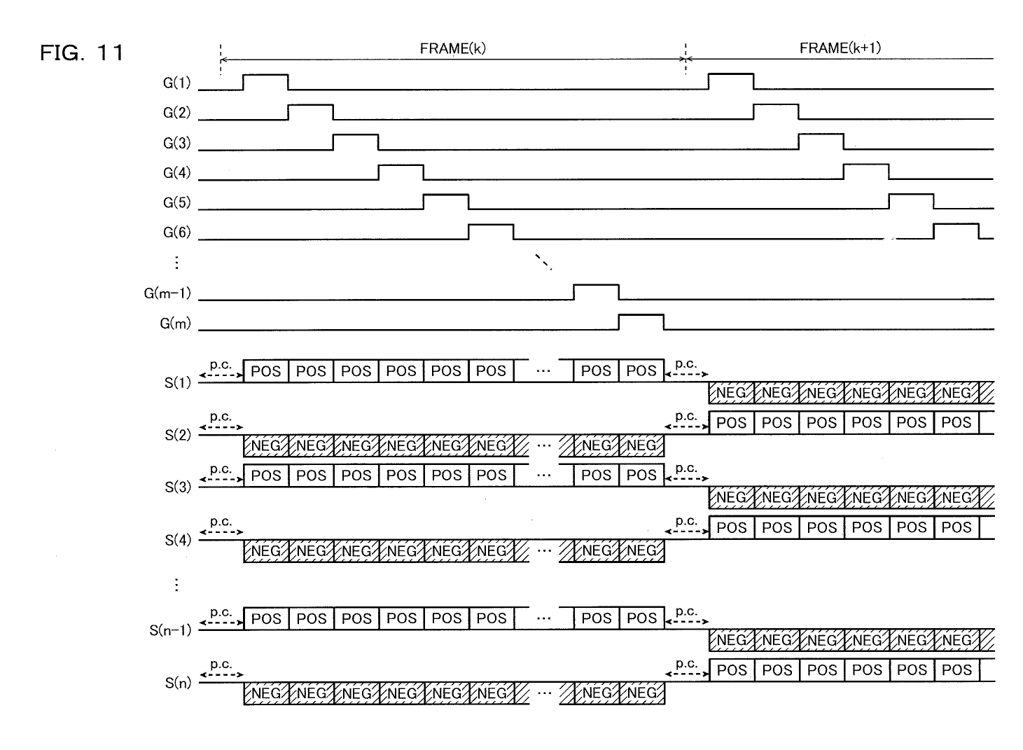

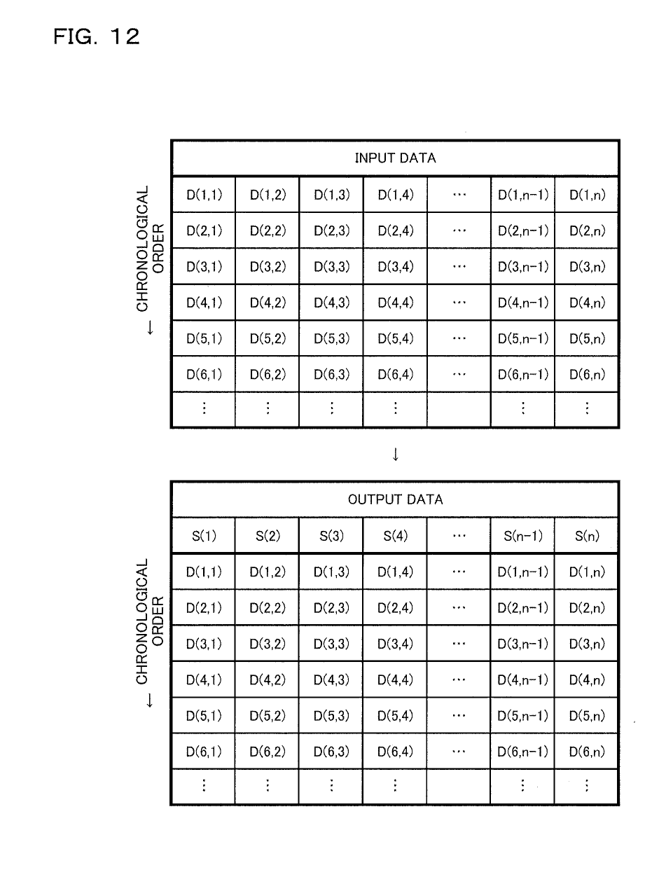

FIG. 11 is a timing chart for describing the liquid crystal drive process of the fourth embodiment, and depicts a state in which voltage is applied to the gate lines G(1) to G(m) and the source lines S(1) to S(n) in sequence from the top. Also, FIG. 12 is a data table for describing the data display process of the fourth embodiment (upper table: input data; lower table: output data (S(1) to S(n)). In FIG. 11, “p.c.” represents a pre-charge interval, and in FIG. 12, the expression D(i, j) (1≦i≦m, 1≦j≦n) represents display data (or the voltage value that corresponds thereto) for a liquid crystal pixel positioned at the coordinate (i, j).

In the k^{th} frame interval FRAME(k), POS voltages (D(i, 1), D(i, 3), . . . , D(i, n−1)) are applied to the source lines S(1), S(3), . . . , S(n−1) and NEG voltages (D(i, 2), D(i, 4), . . . , D(i, n) are applied to the source lines S(2), S(4), . . . , S(n) in the i^{th} row selection interval (G(i)=H). In the (k+1)^{th} frame interval FRAME(k+1), the same liquid crystal drive process and data display process as those described above are carried out after the positive and negative polarities have been inverted.

With such a configuration, the polarity of the voltage to be applied to the source lines S(1) to S(n) is no longer inverted during at least a single frame interval in the case of two-dot inversion driving of the liquid crystal display panel 30 in the same manner as the first to third embodiments described above. Therefore, the capacitative constituents (pixel capacitance, auxiliary capacitance, and wiring capacitance) connected to each of the source lines S(1) to S(n) are no longer required be charged from positive to negative or from negative to positive, and power loss can be considerably reduced.

The liquid crystal display device of the fourth embodiment is different from the first embodiment described above in that one extra signal system (latch, digital/analog converter, buffer amplifier, selector) in the source driver 24 is not required, and a process for rearranging the display data is not required (see FIG. 12). Therefore, an existing source driver can be used without modification.

As shall be apparent, it is also possible to add a multiplexer in similar fashion to the second and third embodiments while using the liquid crystal display device of the fourth embodiment as the basic form.

### SUMMARY

In view of the first to fourth embodiments, the liquid crystal display panel of the present invention has a plurality of gate lines, a plurality of source lines, and a plurality of liquid crystal pixels; and is regarded to have a configuration in which the plurality of source lines and the plurality of liquid crystal pixels are laid out so that the polarity of voltage to be applied to the plurality of liquid crystal pixels is inverted for each dot for the liquid crystal display panel overall, and so that the polarity of voltage to be applied to the plurality of source lines is not inverted for at least an entire row scan interval. Such a configuration makes it possible to provide a liquid crystal display panel that can reduce power loss during dot inversion driving, a liquid crystal drive device for driving the liquid crystal display panel, and a liquid crystal display device that uses the liquid crystal display panel and the liquid crystal drive device.

### INDUSTRIAL APPLICABILITY

The present invention is art that is useful for reducing the power consumption of a liquid crystal display device.

### Other Configuration Examples

In addition to the embodiments described above, the configuration of the present invention can be variously modified in a range that does not depart from the spirit of the invention. In other words, the embodiments described above are examples in all points, and should not be considered be limiting in nature. The technical range of the present invention is as disclosed in the claims and not the description of the embodiments above, and shall be understood to include meanings equivalent to the claims as well as all modifications within the range.

For example, in the embodiments described above, a configuration is given as an example in which a TFT circuit is incorporated in the upper right portion or upper left portion of a pixel, but the configuration of the present invention is not limited thereby; it also being possible to incorporate a TFT circuit in the lower right portion or lower left portion of a pixel.

1. A liquid crystal display panel comprising:
a plurality of gate lines;
a plurality of source lines; and
a plurality of liquid crystal pixels,
wherein the plurality of source lines and the plurality of liquid crystal pixels are laid out so that the polarity of voltage to be applied to the plurality of liquid crystal pixels is inverted for each dot for the liquid crystal display panel overall, and so that the polarity of voltage to be applied to the plurality of source lines is not inverted for at least an entire row scan interval.

2. The liquid crystal display panel of claim 1, wherein
the number of gate lines is m (m≧2);
the number of source lines is (n+1) (n≧2);
the number of liquid crystal pixels is (m×n);
liquid crystal pixels of a first column are connected in the row scanning direction to a source line of the first column every x number of rows (1≦x≦(m/2)) while intervals of x number of rows are skipped;
the liquid crystal pixels of a y^{th} column and the liquid crystal pixels of a (y−1)^{th} column are connected in the row scanning direction to the source line of the y^{th} column (2≦y≦n) in alternating fashion every x number of rows; and
x number of rows of liquid crystal pixels in an n^{th} column are connected in the row scanning direction to the source line of an (n+1)^{th} column while intervals of x number of rows are skipped.

3. The liquid crystal display panel of claim 1, wherein
the number of gate lines is m (m≧2);
the number of source lines is n (n≧2);
the number of liquid crystal pixels is (m×n);
the liquid crystal pixels in a y^{th} column and the liquid crystal pixels of a (y+1)^{th} column are connected in the row scanning direction in alternating fashion every x number of rows (1≦x≦(m/2)) to the source line of the y^{th} column (y=1, 3, 5, . . . , (n−1));
the liquid crystal pixels of the (y+1)^{th} column and the liquid crystal pixels in the y^{th} column are connected in the row scanning direction in alternating fashion every x number of rows to the source line of the (y+1)^{th} column; and
the mutual layout positions of the source line of the y^{th} column and the source line of the (y+1)^{th} column are inverted every x rows in the row scanning direction.

4. A liquid crystal drive device for driving the liquid crystal display panel of claim 1 using a dot inversion drive scheme.

5. A liquid crystal display device comprising a liquid crystal display panel comprising:
a plurality of gate lines;
a plurality of source lines; and
a plurality of liquid crystal pixels,
wherein the plurality of source lines and the plurality of liquid crystal pixels are laid out so that the polarity of voltage to be applied to the plurality of liquid crystal pixels is inverted for each dot for the liquid crystal display panel overall, and so that the polarity of voltage to be applied to the plurality of source lines is not inverted for at least an entire row scan interval, and
the liquid crystal display device further comprising a liquid crystal drive device for driving the liquid crystal display panel using a dot inversion drive scheme.

6. The liquid crystal drive device of claim 5, further comprising:
a multiplexer for distributing in a plurality an output of the liquid crystal drive device and supplying the outputs to the liquid crystal display panel.

7. The liquid crystal drive device of claim 6, wherein the multiplexer is connected to a plurality of source lines to which the same polarity voltage is applied.

8. The liquid crystal drive device of claim 7, wherein the multiplexer is connected to a plurality of consecutive source lines.

9. A liquid crystal drive device for driving the liquid crystal display panel of claim 2 using a dot-inversion drive scheme.

10. The liquid crystal drive device of claim 9, wherein
the liquid crystal drive device switches on the amplifier connected to the source line of the first column and switches off the amplifier connected to the source line of the (n+1)^{th} column in a row in which voltage is to be applied to the source line of the first column; and, conversely switches off the amplifier connected to the source line of the first column and switches on the amplifier connected to the source line of the (n+1)^{th} column in rows in which voltage is to be applied to the source line of the (n+1)^{th} column.

11. The liquid crystal display device of claim 5 wherein in the liquid crystal display panel:
the number of gate lines is m (m≧2);
the number of source lines is (n+1) (n≧2);
the number of liquid crystal pixels is (m×n);
liquid crystal pixels of a first column are connected in the row scanning direction to a source line of the first column every x number of rows (1≦x≦(m/2)) while intervals of x number of rows are skipped;
the liquid crystal pixels of a y^{th} column and the liquid crystal pixels of a (y−1)^{th} column are connected in the row scanning direction to the source line of the y^{th} column (2≦y≦n) in alternating fashion every x number of rows; and
x number of rows of liquid crystal pixels in an n^{th} column are connected in the row scanning direction to the source line of an (n+1)^{th} column while intervals of x number of rows are skipped.

12. The liquid crystal drive device of claim 11, further comprising:
a multiplexer for distributing in a plurality an output of the liquid crystal drive device and supplying the outputs to the liquid crystal display panel.

13. The liquid crystal drive device of claim 12, wherein the multiplexer is connected to a plurality of source lines to which the same polarity voltage is applied.

14. The liquid crystal drive device of claim 13, wherein the multiplexer is connected to a plurality of consecutive source lines.

15. A liquid crystal drive device for driving the liquid crystal display panel of claim 3 using a dot-inversion drive scheme.

16. The liquid crystal display device of claim 5 wherein in the liquid crystal display panel:
the number of gate lines is m (m≧2);
the number of source lines is n (n≧2);
the number of liquid crystal pixels is (m×n);
the liquid crystal pixels in a y^{th} column and the liquid crystal pixels of a (y+1)^{th} column are connected in the row scanning direction in alternating fashion every x number of rows (1≦x≦(m/2)) to the source line of the y^{th} column (y=1, 3, 5, . . . , (n−1));
the liquid crystal pixels of the (y+1)^{th} column and the liquid crystal pixels in the y^{th} column are connected in the row scanning direction in alternating fashion every x number of rows to the source line of the (y+1)^{th} column; and
the mutual layout positions of the source line of the y^{th} column and the source line of the (y+1)^{th} column are inverted every x rows in the row scanning direction.

17. The liquid crystal drive device of claim 16, further comprising:
a multiplexer for distributing in a plurality an output of the liquid crystal drive device and supplying the outputs to the liquid crystal display panel.

18. The liquid crystal drive device of claim 17, wherein the multiplexer is connected to a plurality of source lines to which the same polarity voltage is applied.

19. The liquid crystal drive device of claim 18, wherein the multiplexer is connected to a plurality of consecutive source lines.
